(19) United States
(12) Patent Application Publication
(10) Pub. No.: US 2024/0257204 A1
(43) Pub. Date: Aug. 1, 2024

(54) SYSTEMS AND METHODS FOR PRODUCT ANALYSIS

(71) Applicant: Walmart Apollo, LLC, Bentonville, AR (US)

(72) Inventors: Karthick Sivakumar, Chennai (IN); Radhika Raghu, Chennai (IN); Sreeraman Krishnan, Chennai (IN); Karunashree Saproo, Sunnyvale, CA (US); Amitha Krishnappa, Los Altos, CA (US)

(73) Assignee: Walmart Apollo, LLC, Bentonville, AR (US)

(21) Appl. No.: 18/103,219

(22) Filed: Jan. 30, 2023

(51) Int. Cl. G06Q 30/0601

(52) U.S. Cl. CPC G06Q 30/0629

(57) ABSTRACT

Systems and methods including one or more processors and one or more non-transitory computer readable media storing computing instructions that, when executed on the one or more processors, cause the one or more processors to perform: receiving historical engagement information for products in a marketplace; clustering a first subset of the products based on at least one clustering criterion and based on a set of attributes; identifying a second subset of the products that are similar to the first subset of the products based on at least one similarity criterion; determining a third subset of the products by filtering the second subset of the products based on the historical engagement information for the second subset of the products; determining at least one benchmark for the first subset of the products based on the historical engagement information for the first subset of the products; and determining a lift score for the third subset of the products based on the at least one benchmark. Other embodiments are disclosed.

### TECHNICAL FIELD

This disclosure relates generally to computing system management, and more particularly to systems and methods for product analysis.

### BACKGROUND

Marketplaces are responsible for millions of products at a time. Each of these products includes its own metadata (e.g., price, product type, etc.) that needs to be analyzed by computing systems associated with the marketplaces. However, the metadata for the products can be incorrectly labeled or result in the product being undiscoverable in the marketplace. Accordingly, it would be desirable to have product analysis systems to identify and improve the metadata to improve the operation of computing systems.

### BRIEF DESCRIPTION OF THE DRAWINGS

To facilitate further description of the embodiments, the following drawings are provided in which:

FIG. 1 illustrates a front elevational view of a computer system that is suitable for implementing various embodiments of the systems disclosed in FIG. 3;

FIG. 2 illustrates a representative block diagram of an example of the elements included in the circuit boards inside a chassis of the computer system of FIG. 1;

FIG. 3 illustrates a representative block diagram of a system, according to an embodiment;

FIG. 4 illustrates a flowchart for a method, according to certain embodiments;

FIG. 5A illustrates an exemplary data relationship, according to certain embodiments;

FIG. 5B illustrates an exemplary data relationship, according to certain embodiments;

FIG. 6 illustrates an exemplary threshold calculation, according to certain embodiments; and

FIG. 7 illustrates an exemplary system architecture, according to certain embodiments.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

A number of embodiments can include a system. The system can include one or more processors and one or more non-transitory computer-readable storage devices storing computing instructions. The computing instructions can be configured to run on the one or more processors and cause the one or more processors to perform: receiving historical engagement information for products in a marketplace; clustering a first subset of the products based on at least one clustering criterion and based on a set of attributes; identifying a second subset of the products that are similar to the first subset of the products based on at least one similarity criterion; determining a third subset of the products by filtering the second subset of the products based on the historical engagement information for the second subset of the products; determining at least one benchmark for the first subset of the products based on the historical engagement information for the first subset of the products; and determining a lift score for the third subset of the products based on the at least one benchmark.

Various embodiments include a method. The method can be implemented via execution of computing instructions configured to run at one or more processors and configured to be stored at non-transitory computer-readable media. The method can comprise receiving historical engagement information for products in a marketplace; clustering a first subset of the products based on at least one clustering criterion and based on a set of attributes; identifying a second subset of the products that are similar to the first subset of the products based on at least one similarity criterion; determining a third subset of the products by filtering the second subset of the products based on the historical engagement information for the second subset of the products; determining at least one benchmark for the first subset of the products based on the historical engagement information for the first subset of the products; and determining a lift score for the third subset of the products based on the at least one benchmark.

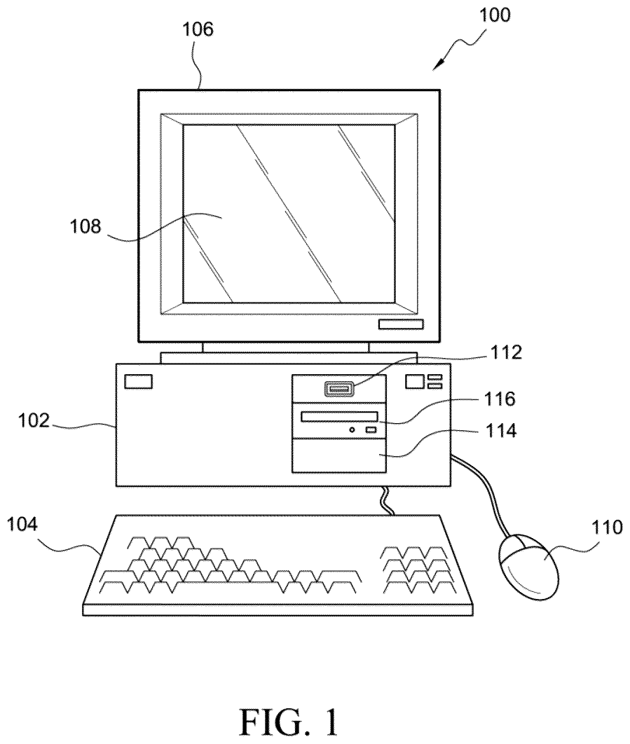

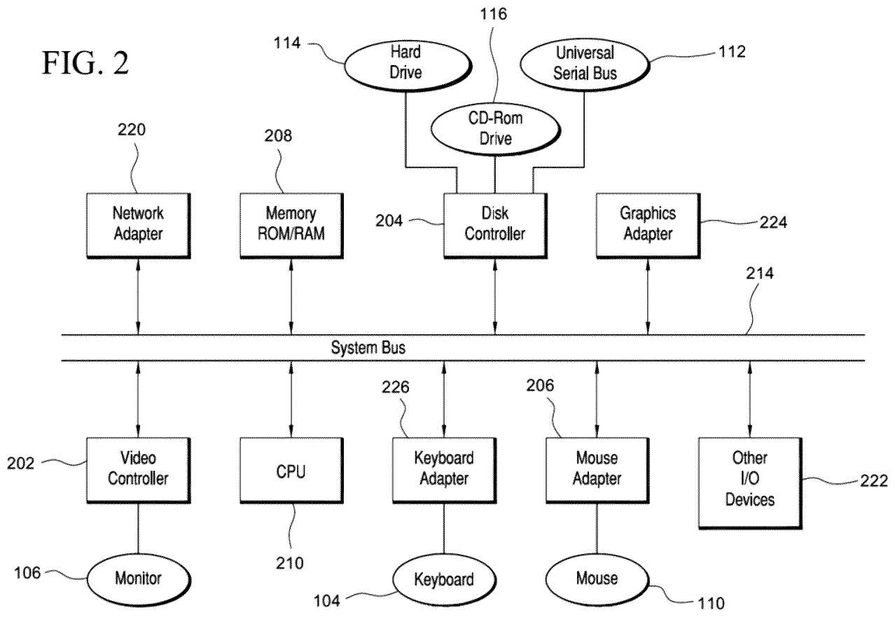

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) non-volatile memory, such as, for example, read only memory (ROM) and/or (ii) volatile memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In these or other embodiments, memory storage unit 208 can comprise (i) non-transitory memory and/or (ii) transitory memory.

In many embodiments, all or a portion of memory storage unit 208 can be referred to as memory storage module(s) and/or memory storage device(s). In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

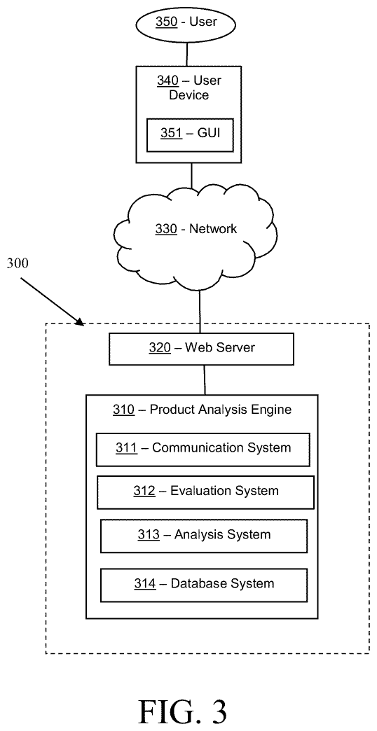

Turning ahead in the drawings, FIG. 3 illustrates a block diagram of a system 300 that can be employed for product analysis, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include a product analysis engine 310 and/or web server 320.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Product analysis engine 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host product analysis engine 310 and/or web server 320. Additional details regarding product analysis engine 310 and/or web server 320 are described herein.

In some embodiments, web server 320 can be in data communication through a network 330 with one or more user devices, such as a user device 340, which also can be part of system 300 in various embodiments. User device 340 can be part of system 300 or external to system 300. Network 330 can be the Internet or another suitable network. In some embodiments, user device 340 can be used by users, such as a user 350. In many embodiments, web server 320 can host one or more websites and/or mobile application servers. For example, web server 320 can host a website, or provide a server that interfaces with an application (e.g., a mobile application), on user device 340, which can allow users (e.g., 350) to interact with infrastructure components, in addition to other suitable activities. In a number of embodiments, web server 320 can interface with product analysis engine 310 when a user (e.g., 350) is viewing infrastructure components in order to assist with the analysis of the infrastructure components.

In some embodiments, an internal network that is not open to the public can be used for communications between product analysis engine 310 and web server 320 within system 300. Accordingly, in some embodiments, product analysis engine 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, California, United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, New York, United States of America. In other specific examples, a head mountable wearable user computer device can comprise the Virtual Retinal Display™ product, or similar product by the University of Washington of Seattle, Washington, United States of America. Meanwhile, in further specific examples, a limb mountable wearable user computer device can comprise the iWatch™ product, or similar product by Apple Inc. of Cupertino, California, United States of America, the Galaxy Gear or similar product of Samsung Group of Samsung Town, Seoul, South Korea, the Moto 360 product or similar product of Motorola of Schaumburg, Illinois, United States of America, and/or the Zip™ product, One™ product, Flex™ product, Charge™ product, Surge™ product, or similar product by Fitbit Inc. of San Francisco, California, United States of America.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Washington, United States of America.

In many embodiments, product analysis engine 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to product analysis engine 310 and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of product analysis engine 310 and/or web server 320. In a similar manner, the processors and/or the non-transitory computer-readable media can be local and/or remote to each other.

Meanwhile, in many embodiments, product analysis engine 310 and/or web server 320 also can be configured to communicate with one or more databases, such as a database system 314. The one or more databases can include historical engagement information, user activity information, and/or machine learning training data, for example, among other data as described herein. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, product analysis engine 310, web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, product analysis engine 310 can include a communication system 311, an evaluation system 312, an analysis system 313, and/or database system 314. In many embodiments, the systems of product analysis engine 310 can be modules of computing instructions (e.g., software modules) stored at non-transitory computer readable media that operate on one or more processors. In other embodiments, the systems of product analysis engine 310 can be implemented in hardware. Product analysis engine 310 and/or web server 320 each can be a computer system, such as computer system 100 (FIG. 1), as described above, and can be a single computer, a single server, or a cluster or collection of computers or servers, or a cloud of computers or servers. In another embodiment, a single computer system can host product analysis engine 310 and/or web server 320. Additional details regarding product analysis engine 310 and the components thereof are described herein.

In many embodiments, user device 340 can comprise graphical user interface (“GUI”) 351. In the same or different embodiments, GUI 351 can be part of and/or displayed by user computer 340, which also can be part of system 300. In some embodiments, GUI 351 can comprise text and/or graphics (image) based user interfaces. In the same or different embodiments, GUI 351 can comprise a heads up display (“HUD”). When GUI 351 comprises a HUD, GUI 351 can be projected onto a medium (e.g., glass, plastic, etc.), displayed in midair as a hologram, or displayed on a display (e.g., monitor 106 (FIG. 1)). In various embodiments, GUI 351 can be color, black and white, and/or greyscale. In many embodiments, GUI 351 can comprise an application running on a computer system, such as computer system 100 (FIG. 1), user computers 340. In the same or different embodiments, GUI 351 can comprise a website accessed through internet 320. In some embodiments, GUI 351 can comprise an eCommerce website. In these or other embodiments, GUI 351 can comprise an administrative (e.g., back end) GUI allowing an administrator to modify and/or change one or more settings in system 300. In the same or different embodiments, GUI 351 can be displayed as or on a virtual reality (VR) and/or augmented reality (AR) system or display. In some embodiments, an interaction with a GUI can comprise a click, a look, a selection, a grab, a view, a purchase, a bid, a swipe, a pinch, a reverse pinch, etc.

In some embodiments, web server 320 can be in data communication through network (e.g., Internet) 330 with user computers (e.g., 340). In certain embodiments, user computers 340 can be desktop computers, laptop computers, smart phones, tablet devices, and/or other endpoint devices. Web server 320 can host one or more websites. For example, web server 320 can host an eCommerce website that allows users to browse and/or search for products, to add products to an electronic shopping cart, and/or to purchase products, in addition to other suitable activities.

In many embodiments, product analysis engine 310, and/or web server 320 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) of product analysis engine 310, and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of product analysis engine 310, and/or web server 320. In a similar manner, the processing module(s) and the memory storage module(s) can be local and/or remote to each other.

In many embodiments, product analysis engine 310, and/or web server 320 can be configured to communicate with one or more user computers 340. In some embodiments, user computers 340 also can be referred to as customer computers. In some embodiments, product analysis engine 310, and/or web server 320 can communicate or interface (e.g., interact) with one or more customer computers (such as user computers 340) through a network or internet 330. Internet 330 can be an intranet that is not open to the public. In further embodiments, Internet 330 can be a mesh network of individual systems. Accordingly, in many embodiments, product analysis engine 310, and/or web server 320 (and/or the software used by such systems) can refer to a back end of system 300 operated by an operator and/or administrator of system 300, and user computers 340 (and/or the software used by such systems) can refer to a front end of system 300 used by one or more users 350, respectively. In some embodiments, users 350 can also be referred to as customers, in which case, user computers 340 can be referred to as customer computers. In these or other embodiments, the operator and/or administrator of system 300 can manage system 300, the processing module(s) of system 300, and/or the memory storage module(s) of system 300 using the input device(s) and/or display device(s) of system 300.

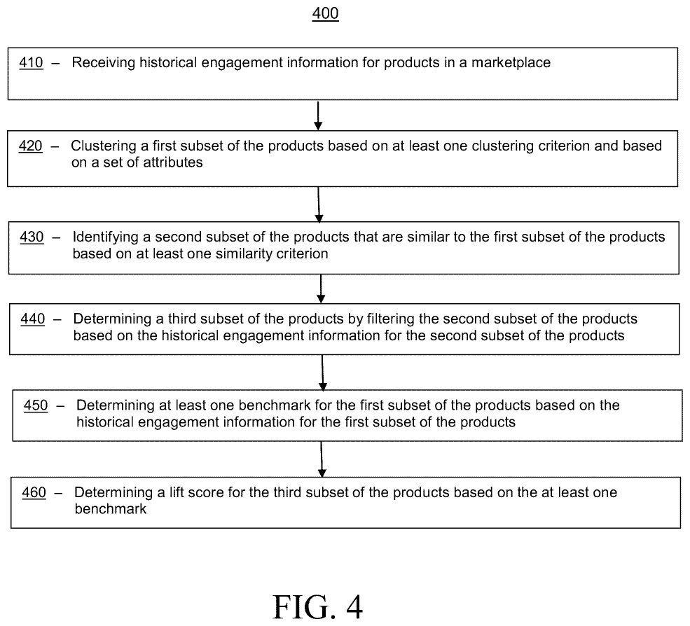

Turning ahead in the drawings, FIG. 4 illustrates a flow chart for a method 400, according to an embodiment. Method 400 is merely exemplary and is not limited to the embodiments presented herein. Method 400 can be employed in many different embodiments or examples not specifically depicted or described herein. In some embodiments, the activities of method 400 can be performed in the order presented. In other embodiments, the activities of method 400 can be performed in any suitable order. In still other embodiments, one or more of the activities of method 400 can be combined or skipped. In many embodiments, system 300 (FIG. 3) can be suitable to perform method 400 and/or one or more of the activities of method 400. In these or other embodiments, one or more of the activities of method 400 can be implemented as one or more computer instructions configured to run at one or more processing modules and configured to be stored at one or more non-transitory memory storage modules. Such non-transitory memory storage modules can be part of a computer system such as product analysis engine 310, web server 320, and/or user device 340 (FIG. 3). The processing module(s) can be similar or identical to the processing module(s) described above with respect to computer system 100 (FIG. 1).

In many embodiments, method 400 can comprise an activity 410 of receiving historical engagement information for products in a marketplace. In some embodiments, the marketplace is an online marketplace such as Walmart.com. In some embodiments, the historical engagement information comprises at least one of the following: an impression, a product view, an add-to-cart, or an order. In many embodiments, an impression is registered when a user views an product's thumbnail in the marketplace, a product view is counted when a user navigates to a full product page, an add-to-cart corresponds to when a product (e.g., an item) is added to a user's cart (e.g., an add to cart engagement), and orders correspond to a number of times an order is placed for a product in the marketplace. During a typical user session in the marketplace, the sequence of events (also referred to as an engagement funnel) is as follows: 1) impression, 2) product view, 3) add-to-cart, and 4) order. In some embodiments, a conversion rate can be determined as a ratio of engagement between stages of the sequence of events. For example, the impression to product view conversion rate is the ratio between number of product views and number of impressions and can provide an indication of the effect of primary image and product name in converting an impression engagement to a product view. Product view to add-to-cart can provide an indication of the quality of content in the product page in enabling the customer to make a purchase decision. Product view to order can provide an indication on whether there are other factors involved in the conversion of a product view to sale. For example, a high PV to ATC conversion and a low PV to order conversion could indicate factors other than content affecting the purchase decision.

In many embodiments, method 400 can comprise an activity 420 of clustering a first subset of the products based on at least one clustering criterion and based on a set of attributes. In some embodiments, the clustering criterion comprises one or more categories of the products. For example, the clustering criterion corresponds to a category of products such as “beds” or “lighting.” In some embodiments, the set of attributes includes at least one of the following: a number of reviews, an average rating, a quality score, a number of orders in a season, or a number of impressions in a season. For example, a season can refer to a period of time such as a week, a month, one-month before a holiday (e.g., Halloween, Christmas, etc.), two-months before a holiday. In some embodiments, the set of attributes are collected from the previous two years. For example, to analyze an upcoming Christmas season, activity 420 can obtain the set of attributes for the previous two years for the Christmas season.

In some embodiments, clustering the first subset of the products can include clustering the products based on the clustering criterion to determine a category (e.g., “beds,” “lighting,” etc.). Based on the category, activity 420 can include clustering the products for the category of the products using k-means clustering based on the set of attributes. For example, the category can be “beds” and activity 420 can utilize k-means clustering to cluster the products in the “beds” category based on a sets of attributes such as number of ratings and number of orders for a season. However, any combination of attributes can be used for clustering. Activity 420 can include identifying a cluster of the products with a highest quantity of the products as the first subset of the products. For example, the highest cluster based on quantity is picked as the baseline with high performing products for that season and that category.

In many embodiments, method 400 can comprise an activity 430 of identifying a second subset of the products that are similar to the first subset of the products based on at least one similarity criterion. In some embodiments, the similarity criterion corresponds to products that are in categories that are similar to the category of the first subset of the products. In some embodiments, the similarity criterion is based on products that sound similar to the first subset of the products. For example, activity 430 can include identifying a group of the products that are similar to the first subset of the products based on an output of an audio similarity algorithm. In some embodiments, the audio similarity algorithm is a Soundex match algorithm. The Soundex match algorithm is a phonetic algorithm for indexing and matching names by sound, as pronounced in English. In some embodiments, activity 430 can include determining a Levenshtein distance between the group of the products and the first subset of the products. The Levenshtein distance between two words is the minimum number of single-character edits (e.g., insertions, deletions or substitutions) required to change one word into the other. In some embodiments, activity 430 can include identifying the second subset of the products as being a portion of the group of the products that are within a threshold Levenshtein distance of the Levenshtein distance for the first subset of the products. For example, the products with less than a 20% to 50% distance (e.g., a 30% distance) compared to the first subset of the products can be identified as the second subset of the products.

In many embodiments, method 400 can comprise an activity 440 of determining a third subset of the products by filtering the second subset of the products based on the historical engagement information for the second subset of the products. For example, activity 440 can include identifying historical engagement information for the second subset of the products such as impressions, product views, add-to-carts, and orders. In some embodiments, activity 440 can include comparing the historical engagement information for the second subset of the products to the historical engagement information for the first subset of the products. For example, this can include comparing the number of impressions, number of orders, etc. In some embodiments, activity 440 can include identifying the third subset of the products as being a portion of the second subset of the products that are within an engagement threshold of an engagement for the first subset of the products. For example, products from the second subset of the products that have at least a 40% to 60% lower engagement (e.g., a 50% lower engagement) compared to the first subset of the products are identified as the third subset of the products. In some embodiments, the third subset of the products is displayed on a GUI (e.g., the GUI 351 (FIG. 3)) to users to improve the visibility of the third subset of the products. For example, the third subset of the products can be displayed more frequently than in the past, and this increased display frequency can be based on a lift score, as explained below. In some embodiments, activities 450 and 460 can be utilized to determine the performance of the third subset of the products.

In many embodiments, method 400 can comprise an activity 450 of determining at least one benchmark for the first subset of the products based on the historical engagement information for the first subset of the products. In some embodiments, activity 450 can include clustering the first subset of the products into age buckets based on lifecycle information for the first subset of the products. For example, the age buckets can correspond to 0-30 days from the date the product was published in the marketplace, 30-90 days from the date the product was published in the marketplace, 91-365 days from the date the product was published in the marketplace, 365-537 days from the date the product was published in the marketplace, 538-900 days from the date the product was published in the marketplace, and >900 days from the date the product was published in the marketplace. In some embodiments, the lifecycle information can correspond to product age, product category, and seasonality. Product age corresponds to older and well-established products having higher engagement when compared to newer products and include different thresholds, which correspond to the different age buckets. Product categories have different threshold because each category has unique engagement behavior. Seasonality corresponds to the fluctuation in engagement for different products during different seasons. For example, a fur coat typically has higher engagement during the winter season than any other season. In some embodiments, thresholds can be derived separately for a regular period (e.g., high engagement, in season) and an outlier period (e.g., low engagement, out of season). For example, for a given category, the benchmarks are generated from a random sample of historical data. The data is collected and can be divided based on seasonality into regular data and outlier data.

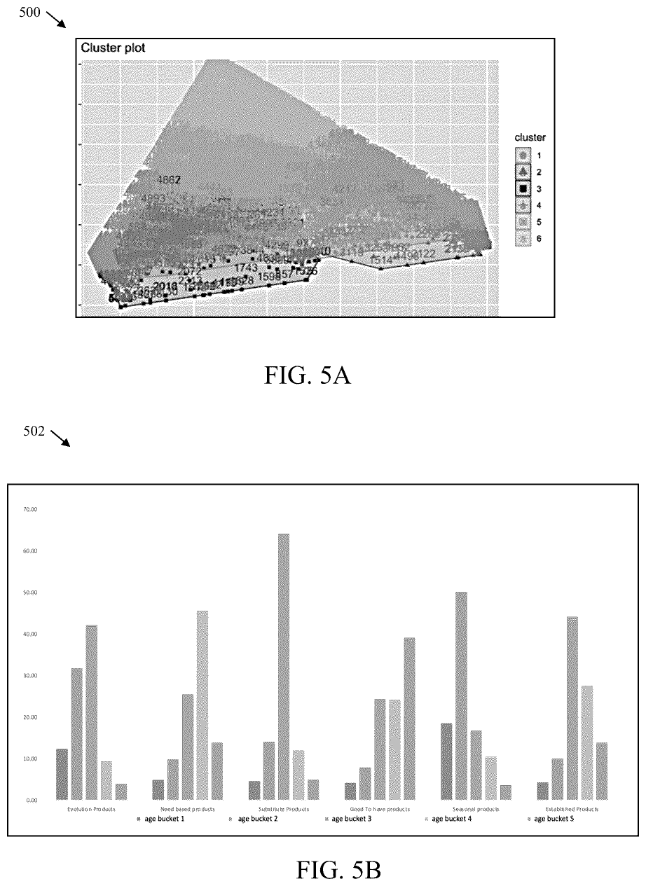

Turning briefly to FIGS. 5A and 5B, example data relationships are illustrated. In the illustrated embodiment of FIG. 5A, a cluster plot 500 is illustrated that clusters products based on the historical engagement information. In the illustrated embodiment of FIG. 5B, a bar graph 502 is illustrated that shows six product categories and the expected engagement levels for each age bucket. For example, the first category on the left most portion of the bar graph 502 corresponds to evolution products and illustrates the third age bucket having the highest engagement for this category. To convert the data relationships in FIGS. 5A and 5B of the original population to normalized data, Central Limit Theorem (CLT) is utilized by taking multiple samples and aggregating their means to create normalized data.

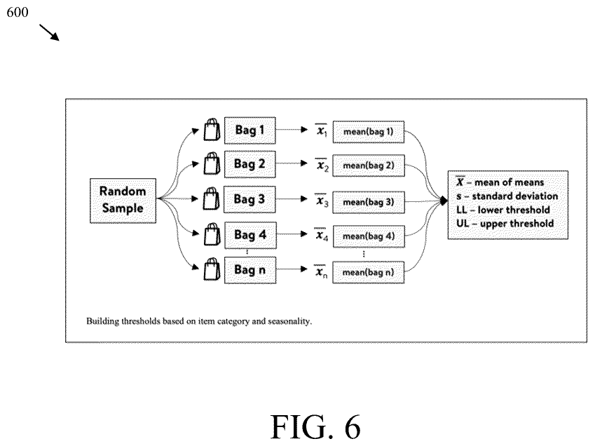

Turning to FIG. 6, an example threshold calculation is illustrated. In some embodiments, activity 450 (FIG. 4) can include determining thresholds based on product category and seasonality. As illustrated in FIG. 6, the benchmarks are generated from a random sample of historical data. The data is collected and divided based on seasonality into regular data and outlier data. Each of these sections are distributed into n-bags and the mean of each bag is generated at product age bucket level. A mean of means is generated as the final aggregate value for each of the 5 product age buckets along with the standard deviation (SD). Returning to FIG. 4, activity 450 can include determining an upper threshold for the benchmark based on an equation: mean+SD, wherein SD is the standard deviation, and determining a lower threshold for the benchmark based on an equation: mean−SD. Table 1 illustrates the benchmarks (e.g., upper threshold and lower threshold) for each of the metrics (e.g., impressions, product view, add-to-cart, order).

TABLE 1

| | Lower | |
|---|---|---|
| Metrics | threshold | Upper threshold |
| Metric 1 = | x₁ | X₁ |
| m₁ⁱ | | |
| Metric 2 = | x₂ | X₂ |
| m₂ⁱ | | |
| Metric 3 = | x₃ | X₃ |
| m₃ⁱ | | |
| Metric 4 = | x₄ | X₄ |
| m₄ⁱ | | |

In many embodiments, method 400 can comprise an activity 460 of determining a lift score for the third subset of the products based on the at least one benchmark. In some embodiments, determining the lift score for the third subset of the products based on the benchmarks comprises determining a par score for each product in the third subset of the products based on an equation comprising:

$$Par Score ( P ) = \{ \begin{matrix}{m}_{n}^{i} > {X}_{n} ; Above Par \\ {m}_{n}^{i} < {x}_{n} ; Below Par \\ {m}_{n}^{i} > {x}_{n} and {m}_{n}^{i} < {X}_{n} ; On Par \\ {m}_{n}^{i} = 0 or {m}_{n}^{i} is null ; No engagement\end{matrix}$$

wherein i is a product, mₙ is a metric, Xₙ is an upper threshold, and xₙ is a lower threshold. Metric corresponds to at least one of impression, product view, add-to-cart, or order. For example, for category Table Lighting, the following benchmarks were obtained for the impressions metric:

| | Lower | Upper | |
|---|---|---|---|
| Metrics | threshold | threshold | Mean |
| Impressions | 2759 | 3795 | 3277 |

In some embodiments, when the metric is above the upper threshold the product is determined to be above par, when the metric is below the lower threshold is below par, and when the metric is in between the upper threshold and the lower threshold the product is on par. In some embodiments, activity 460 can include identifying a group of the third subset of the products that have a par score that satisfies a threshold. For example, the threshold can be products that are on par, above par, or below par.

In some embodiments, activity 460 can include determining the lift score for the group of the third subset of the products that has a par score that satisfies the threshold based on an equation comprising:

$$Lift \% = ( {m}_{n}^{i} - {X}_{n} ) / {X}_{n}$$

For example, consider product A in category “Beds”, compared against the threshold values in the lifecycle stage of 91-365 days from publish date. The following table illustrates the benchmark values and the par and lift scores based on the above calculations. As illustrated by the above par scores and the Lift %, the activities 420-440 resulted in an improvement to the engagement for product A.

| | | Lower | Upper | | | |
|---|---|---|---|---|---|---|
| | | Thresh- | Thresh- | | Lift | |
| | Value | old | old | Mean | % | Par Score |
| Impressions | 22536 | 3787 | 3959 | 3873 | 469% | Above Par |
| Product View | 139 | 50 | 60 | 55 | 132% | Above Par |
| Add to Cart | 8 | 3 | 5 | 4 | 60% | Above Par |
| Orders | 0 | | | | | No |
| | | | | | | engagement |

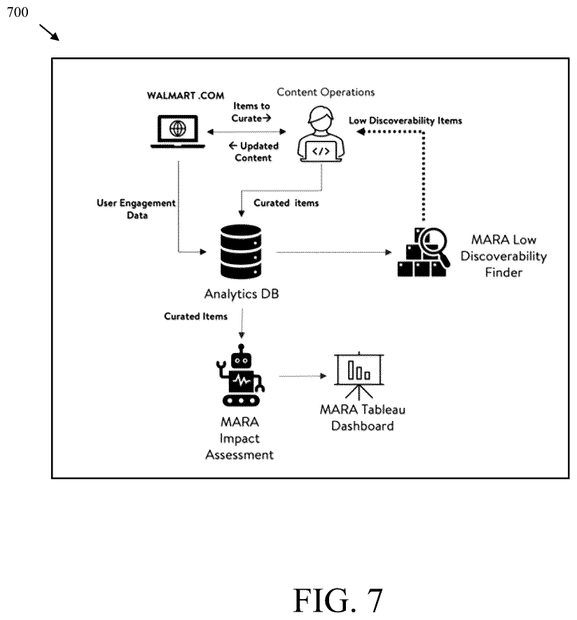

Turning to FIG. 7, an exemplary system architecture 700 is illustrated. The system architecture illustrates an exemplary feedback loop that can improve product analysis. For example, Walmart.com corresponds to the marketplace and can collect user engagement data (e.g., impressions, product view, add-to-carts, orders, etc.) based on user sessions. The marketplace also sends new products (e.g., items) that need to be curated to content operations. Content operations provides the new products with metadata to allow them to be searchable in the marketplace. The curated items and user engagement data are transmitted to the analytics database (DB). The analytics database can transmit the curated items and the user engagement data to the measure analyze reinforced analytics (MARA) low discoverability finder which performs the activities 410-440 (FIG. 4) to identify products that have low engagement. The low discoverability products can be transmitted back to the content operations to be re-curated to improve their engagement. Once the low discoverability items are re-curated, they can be published on the marketplace and updated user engagement data can be generated. The curated items and the updated user engagement data can be transmitted to the MARA impact assessment engine to perform activities 450-460 (FIG. 4) to determine the impact of activities 410-440 (FIG. 4).

Returning to FIG. 3, in several embodiments, communication system 311 can at least partially perform activity 410 (FIG. 4).

In several embodiments, evaluation system 312 can at least partially perform activity 420 (FIG. 4), and/or activity 430 (FIG. 4), and/or activity 440 (FIG. 4).

In a number of embodiments, analysis system 313 can at least partially perform activity 450 (FIG. 4), and/or activity 460 (FIG. 4).

In a number of embodiments, web server 320 can at least partially perform method 400.

Embodiments disclosed herein are directed to a combination of a proactive low discoverability identification model and a benchmark based impact assessment model that assess the impact post content curation. The result of which is a scalable solution that provides directional insights on the effectiveness of content curation in a low turnaround time. This enables the operational teams to react faster and adapt to the market needs and customer engagement. Standard approaches like A/B test and causal impact analysis are available in the market. However, they have the following limitations: 1) A generic A/B test approach used across the industry is difficult to scale as that would entail duplicating several petabytes of data across various systems. This requires accurate telemetry and replication of data pipelines involving large engineering effort. 2) A naive causal impact analysis solution is not effective due to variety and the dynamic nature of the web content. The causal impact methods consider a time series and assess the change from the point of intervention. It is computationally expensive to generate the best set of controls in a large ecommerce catalog. Embodiments disclosed herein provide the ability for content operations to identify the impact of their content curation efforts with quick turnaround times. Embodiments disclosed herein reduce manual data gathering, cleansing and assessment per product type. The system architecture and methodology is fast in assessing the impact of curation on items, completing assessment of ˜10 k items in a day. The effort to assess the impact of ˜200 product types can take close to 10 days each, amounting to 2,000 days of effort. Embodiments disclosed herein reduced the turnaround time to 42 days for the same.

In many embodiments, the techniques described herein can be used continuously at a scale that cannot be reasonably performed using manual techniques or the human mind. For example, processing millions of products within milliseconds cannot be feasibly completed by a human

In a number of embodiments, the techniques described herein can solve a technical problem that arises only within the realm of computer networks, product analysis in a web-based marketplace does not exist outside the realm of computer networks.

In many embodiments, the techniques described herein can solve a technical problem in a related field that cannot be solved outside the context of computer networks. Specifically, the techniques described herein cannot be used outside the context of computer networks due to a lack of data and because the product analysis system cannot be performed without a computer system and/or network.

Although systems and methods for product analysis have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-7 may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when executed on the one or more processors, cause the one or more processors to perform:
receiving historical engagement information for products in a marketplace;
clustering a first subset of the products based on at least one clustering criterion and based on a set of attributes;
identifying a second subset of the products that are similar to the first subset of the products based on at least one similarity criterion;
determining a third subset of the products by filtering the second subset of the products based on the historical engagement information for the second subset of the products;
determining at least one benchmark for the first subset of the products based on the historical engagement information for the first subset of the products; and
determining a lift score for the third subset of the products based on the at least one benchmark.

2. The system of claim 1, wherein the historical engagement information comprises at least one of the following: an impression, a product view, an add-to-cart, or an order.

3. The system of claim 1, wherein clustering the first subset of the products further comprises:
clustering the products based on the at least one clustering criterion, wherein the clustering criterion comprises one or more categories of the products;
clustering the products for the one or more categories of the products using k-means clustering based on the set of attributes; and
identifying a cluster of the products with a highest quantity of the products as the first subset of the products.

4. The system of claim 3, wherein the set of attributes includes at least one of the following: a number of reviews, an average rating, a quality score, a number of orders in a season, or a number of impressions in a season.

5. The system of claim 1, wherein identifying the second subset of the products that are similar to the first subset of the products based on the at least one similarity criterion further comprises:
identifying a group of the products that are similar to the first subset of the products based on an output of an audio similarity algorithm;
determining a Levenshtein distance between the group of the products and the first subset of the products; and
identifying the second subset of the products as being a portion of the group of the products that are within a threshold Levenshtein distance of the Levenshtein distance for the first subset of the products.

6. The system of claim 1, wherein determining the third subset of the products by filtering the second subset of the products based on the historical engagement information for the second subset of the products further comprises:
identifying the historical engagement information for the second subset of the products;
comparing the historical engagement information for the second subset of the products to the historical engagement information for the first subset of the products; and
identifying the third subset of the products as being a portion of the second subset of the products that are within an engagement threshold of an engagement for the first subset of the products.

7. The system of claim 1, wherein determining the at least one benchmark for the first subset of the products based on the historical engagement information for the first subset of the products further comprises:
clustering the first subset of the products into age buckets based on lifecycle information for the first subset of the products;
determining a mean for each of the age buckets;
determining a standard deviation based on the mean for each of the age buckets;
determining an upper threshold for the benchmark based on an equation: mean+SD, wherein SD is the standard deviation; and
determining a lower threshold for the benchmark based on an equation: mean−SD.

8. The system of claim 1, wherein determining the lift score for the third subset of the products based on the benchmarks further comprises determining a par score for each product in the third subset of the products based on an equation comprising:
$$Par Score ( P ) = \{ \begin{matrix}{m}_{n}^{i} > {X}_{n} ; Above Par \\ {m}_{n}^{i} < {x}_{n} ; Below Par \\ {m}_{n}^{i} > {x}_{n} and {m}_{n}^{i} < {X}_{n} ; On Par \\ {m}_{n}^{i} = 0 or {m}_{n}^{i} is null ; No engagement\end{matrix}$$
wherein i is a product, mₙ is a metric, Xₙ is an upper threshold, and xₙ is a lower threshold.

9. The system of claim 8, wherein determining the lift score for the third subset of the products based on the benchmarks further comprises identifying a group of the third subset of the products that have a par score that satisfies a threshold.

10. The system of claim 9, wherein determining the lift score for the third subset of the products based on the benchmarks further comprises:
determining the lift score for the group of the third subset of the products that has a par score that satisfies the threshold based on an equation comprising:
$$Lift \% = ( {m}_{n}^{i} - {X}_{n} ) / {X}_{n}$$

11. A method implemented via execution of computing instructions configured to run at one or more processors and configured to be stored at non-transitory computer-readable media, the method comprising:
receiving historical engagement information for products in a marketplace;
clustering a first subset of the products based on at least one clustering criterion and based on a set of attributes;
identifying a second subset of the products that are similar to the first subset of the products based on at least one similarity criterion;
determining a third subset of the products by filtering the second subset of the products based on the historical engagement information for the second subset of the products;
determining at least one benchmark for the first subset of the products based on the historical engagement information for the first subset of the products; and
determining a lift score for the third subset of the products based on the at least one benchmark.

12. The method of claim 11, wherein the historical engagement information comprises at least one of the following: an impression, a product view, an add-to-cart, or an order.

13. The method of claim 11, wherein clustering the first subset of the products further comprises:
clustering the products based on the at least one clustering criterion, wherein the clustering criterion comprises one or more categories of the products;
clustering the products for the one or more categories of the products using k-means clustering based on the set of attributes; and
identifying a cluster of the products with a highest quantity of the products as the first subset of the products.

14. The method of claim 13, wherein the set of attributes includes at least one of the following: a number of reviews, an average rating, a quality score, a number of orders in a season, or a number of impressions in a season.

15. The method of claim 11, wherein identifying the second subset of the products that are similar to the first subset of the products based on the at least one similarity criterion further comprises:
identifying a group of the products that are similar to the first subset of the products based on an output of an audio similarity algorithm;
determining a Levenshtein distance between the group of the products and the first subset of the products; and
identifying the second subset of the products as being a portion of the group of the products that are within a threshold Levenshtein distance of the Levenshtein distance for the first subset of the products.

16. The method of claim 11, wherein determining the third subset of the products by filtering the second subset of the products based on the historical engagement information for the second subset of the products further comprises:
identifying the historical engagement information for the second subset of the products;
comparing the historical engagement information for the second subset of the products to the historical engagement information for the first subset of the products; and
identifying the third subset of the products as being a portion of the second subset of the products that are within an engagement threshold of an engagement for the first subset of the products.

17. The method of claim 11, wherein determining the at least one benchmark for the first subset of the products based on the historical engagement information for the first subset of the products further comprises:
clustering the first subset of the products into age buckets based on lifecycle information for the first subset of the products;
determining a mean for each of the age buckets;
determining a standard deviation based on the mean for each of the age buckets;
determining an upper threshold for the benchmark based on an equation: mean+SD, wherein SD is the standard deviation; and
determining a lower threshold for the benchmark based on an equation: mean−SD.

18. The method of claim 11, wherein determining the lift score for the third subset of the products based on the benchmarks further comprises determining a par score for each product in the third subset of the products based on an equation comprising:
$$Par Score ( P ) = \{ \begin{matrix}{m}_{n}^{i} > {X}_{n} ; Above Par \\ {m}_{n}^{i} < {x}_{n} ; Below Par \\ {m}_{n}^{i} > {x}_{n} and {m}_{n}^{i} < {X}_{n} ; On Par \\ {m}_{n}^{i} = 0 or {m}_{n}^{i} is null ; No engagement\end{matrix}$$
wherein i is a product, mₙ is a metric, Xₙ is an upper threshold, and xₙ is a lower threshold.

19. The method of claim 18, wherein determining the lift score for the third subset of the products based on the benchmarks further comprises identifying a group of the third subset of the products that have a par score that satisfies a threshold.

20. The method of claim 19, wherein determining the lift score for the third subset of the products based on the benchmarks further comprises:
determining the lift score for the group of the third subset of the products that has a par score that satisfies the threshold based on an equation comprising:
$$Lift \% = ( {m}_{n}^{i} - {X}_{n} ) / {X}_{n} .$$
